(19) United States
(12) Patent Application Publication
(10) Pub. No.: US 2008/0111793 A1
(43) Pub. Date: May 15, 2008

(54) METHOD AND APPARATUS FOR IMPLEMENTING MAGNIFICATION AND EXTENSION OF KEYPADS USING A DYNAMIC TOUCH SCREEN

(76) Inventors: Amanda E. Peters, Rochester, MN (US); Michael Justin TerAvest, Mountain View, CA (US); Andrew Thomas Thorstensen, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/559,439

(22) Filed: Nov. 14, 2006

(51) Int. Cl. G06F 3/041

(52) U.S. Cl. 345/173

(57) ABSTRACT

A method, and apparatus are provided for implementing magnification and extension of keypads using a dynamic touch screen. The dynamic touch-screen generating device includes a processor coupled to a projector for generating and projecting an image onto a surface, and a camera for detecting a user activity on the projected image. The dynamic touch-screen generating device identifies a user selection and applies the identified user selection to an associated functional device, such as a cellular phone, PDA, or GPS navigator.

### FIELD OF THE INVENTION

The present invention relates generally to the data processing field, and more particularly, relates to a method, and apparatus for implementing magnification and extension of keypads using a dynamic touch screen.

### DESCRIPTION OF THE RELATED ART

Currently technology and various devices or gadgets continue to be made smaller. This creates a problem however for devices requiring input from the user. As the device gets smaller, the keypad consequently gets smaller. This makes it increasingly difficult for people with vision impairments to discern the characters on the keypad or those with limited dexterity to make the desired selections.

As devices are decreasing in size, it may be beneficial to eliminate the keypad altogether or to add the option of a keypad to devices that do not currently have that option.

A satisfactory solution to this problem is not currently available. Many devices requiring keypads, such as cellular phones, offer larger sized with enlarged keypads. This allows easier viewing and selection of the desired keys, but sacrifices the small easily transportable size.

Others offer voice-activated service, but this can be inaccurate, less private, or not convenient depending upon the user's surroundings. To avoid some of the problems one arrangement includes voice recognition technology and offering connection service to a live phone operator who makes a connection to the number requested by the user.

Other suppliers provide keypads and keyboards with large keys that can be connected to devices like ipods, cellular phones, personal data assistants (PDAs), or global positioning service (GPS) navigators. One such keyboard is made from a silicon based material that can withstand contact with liquid. The separate keyboards, however, require the user to carry another piece of hardware with them that must be large enough to allow for easily read and accessed keys.

With the increasing consumer usage of portable devices, such as cellular phones, PDAs, GPS navigators, and the like, a need exists for an effective mechanism for offering a magnified or extended keypad.

### SUMMARY OF THE INVENTION

A principal aspect of the present invention is to provide a method, and apparatus for implementing magnification and extension of keypads using a dynamic touch screen. Other important aspects of the present invention are to provide such method, and apparatus for implementing magnification and extension of keypads using a dynamic touch screen substantially without negative effect and that overcome many of the disadvantages of prior art arrangements.

In brief, a method, and apparatus are provided for implementing magnification and extension of keypads using a dynamic touch screen. The dynamic touch-screen generating device includes a processor coupled to a projector for generating and projecting an image onto a surface, and a camera for detecting a user activity on the projected image. The dynamic touch-screen generating device identifies a user selection and applies the identified user selection to an associated functional device.

In accordance with features of the invention, a memory associated with the processor stores a computer vision program, device keyboard image magnification and extended keypad control rules, and size stability control rules for implementing magnification and extension of keypads, initialization processing and movement processing including jitter control using the dynamic touch screen. The associated functional device includes, for example, a cellular phone, a personal data assistant (PDA), or a global positioning service (GPS) navigator.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating exemplary system for implementing magnification and extension of keypads using a dynamic touch screen in accordance with the preferred embodiment;

FIG. 2 is a block diagram representation illustrating an exemplary ED-NANO device of the system of FIG. 1 for implementing magnification and extension of keypads using a dynamic touch screen in accordance with the preferred embodiment;

FIG. 3 is a flow chart illustrating exemplary steps for implementing extension of keypads using a dynamic touch screen in accordance with the preferred embodiment;

FIG. 4 is a flow chart illustrating exemplary steps for implementing magnification of keypads using a dynamic touch screen in accordance with the preferred embodiment;

FIG. 5 is a flow chart illustrating exemplary initialization processing steps in accordance with the preferred embodiment;

FIG. 6 is a flow chart illustrating exemplary movement processing steps in accordance with the preferred embodiment; and

FIG. 7 is a block diagram illustrating a computer program product in accordance with the preferred embodiment.

### DETAILED DESCRIPTION OF THE PREFERRED EMBODIMENTS

“Transforming Surfaces into Touch-Screens” by Claudio Pinhanez et al. IBM Research Division, Thomas J. Watson Research Center, RC2273 (WO112-016), Dec. 4, 2001 Computer Science, discloses an Everywhere Displays (ED) technology and is herein incorporated by reference in its entirety. The ED system is a product of International Business Machines (IBM) Corp. that allows every surface in a space to be transformed into a projected touch screen display.

The ED system uses a computer vision system including a liquid crystal display (LCD) projector, a computer-controlled pan/tilt mirror, a video camera with a pan/tilt head, and a computer. The ED system eliminates the need to wire surfaces for use with sensing devices, use monitors or other sensing devices without requiring users to wear any device. The mirror of the ED system deflects an image of the projector onto a surface and a video camera detects the hand or body activity onto the projected area. The ED system determines what option the user has selected via touch recognizing gestures. This enables interaction capabilities similar to those found in touch-screen displays. The ED system is easily reconfigured to create displays on any surface in a room, and can simultaneously steer the mirror and the camera around the environment. The ED system typically is used for retail signs, and the like in a retail store environment.

In accordance with features of the invention, a method is provided for applying a dynamic touch screen generating device to portable devices in order to magnify and produce extended keypads on any surface. An enhanced dynamic touch screen generating device or an ED-NANO device enables generating extended keypads and magnifying keypads for use with an associated mobile device, such as a cellular phone, a personal data assistant (PDA), or a global positioning service (GPS) navigator.

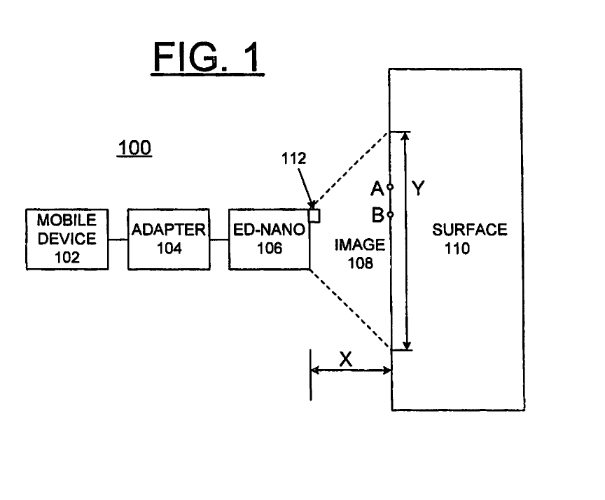

Having reference now to the drawings, in FIG. 1, there is shown an exemplary system generally designated by the reference character 100 for implementing magnification and extension of keypads using a dynamic touch screen in accordance with the preferred embodiment. System 100 includes a mobile device 102 optionally coupled by an adapter 104 to an ED-NANO device 106 in accordance with the preferred embodiment. The ED-NANO device 106 generates and projects an image 108 onto a surface 110.

System 100 including the ED-NANO device 106 is a hand-held, portable device. System 100 includes a distance image finder 112 for determining distance from a selected pair of points, such as indicated as A and B in FIG. 1. Optionally, the ED-NANO device 106 is provided as an integral unit with the mobile device 102. Alternatively, the ED-NANO device 106 is provided as a separate unitary device and then used with the mobile device 102, for example, through a plug in connection via the adapter 104.

In accordance with features of the invention, by simplifying and scaling down the ED system to create the ED-NANO device, an elegant solution is provided to the problem of magnifying keypads and providing keypads for various portable functional devices. The ED-NANO device is a compact device, for example, having a size of a key-chain, and is implemented using existing technology.

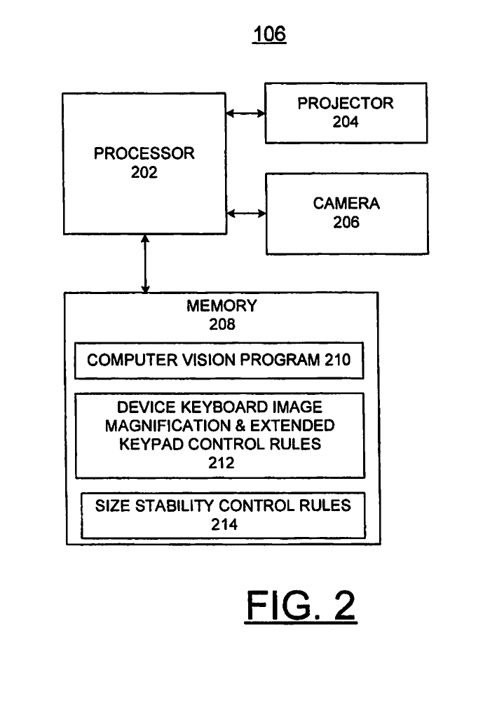

Referring now FIG. 2, there is shown an exemplary ED-NANO device 106 of the system 100 for implementing magnification and extension of keypads using a dynamic touch screen in accordance with the preferred embodiment. The ED-NANO device 106 includes a processor 202 coupled to a projector 204 for generating and projecting images 108 onto an available surface 110, and a camera 206 for detecting a user activity on the projected image. Processor 202 of the ED-NANO 106 through light and image processing determines the user selection and applies the user selection to an associated device 102.

The ED-NANO device 106 includes a memory 208 storing a computer vision program 210, device keyboard image magnification and extended keypad control rules 212, and size stability control rules 214 for implementing magnification and extension of keypads, initialization processing and movement processing including jitter control using a dynamic touch screen in accordance with the preferred embodiment.

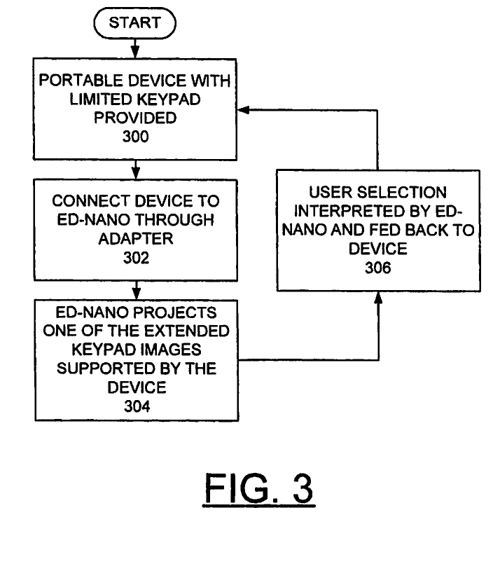

Various commercially available devices can be used for the processor 202. Processor 202 is suitably programmed by the computer vision program 210, device keyboard image magnification and extended keypad control rules 212, and size stability control rules 214 to execute the flowcharts of FIGS. 3, 4, 5, and 6, for implementing methods for magnification and extension of keypads, initialization processing and movement processing using a dynamic touch screen in accordance with the preferred embodiment.

Device keyboard image magnification and extended keypad control rules 212 are stored in accordance with a particularly type of the mobile device 102 for selectively implementing enhanced dynamic touch screen functions in accordance with the preferred embodiment. For example, an extended keypad including projected keys for the letters of the alphabet and optionally multiple numbers is one of the keypad images supported by the ED-NANO device 106.

Size stability control rules 214 are stored for selectively implementing enhanced dynamic touch screen sizing and image stabilization in accordance with the preferred embodiment. In use of the ED-NANO device 106, a user holds the device a variable distance away from a surface 110, indicated by X in FIG. 1, in order to create a touch screen on that surface.

Through calculation and interpretation of the camera's retrieval of the surface information and image projection, the ED-NANO device 106 calculates on the fly the necessary size, such as indicated by Y in FIG. 1, to be projected. This insures that the dynamic touch screen is a predefined desired size no matter how far the user is from the projection surface 110.

In accordance with features of the invention, methods are provided for initialization processing and movement processing to ensure the stability of the projected size and position of projected image, and providing jitter control. A generally fixed position is maintained with the camera 206 recording two positions, such as A and B on the surface 110 of the projected image 108, providing fixation on both the X and Y axis of the two dimensional projected image.

In accordance with features of the invention, in the process to keep the size substantially fixed the distance image finder 112 uses a beam in the infrared spectrum that can be isolated by the camera 206. The image of this infrared spectrum beam is used to determine the distance between the ED-NANO device 106 of system 100 and the projection surface 110. The size of the generated image or dynamic touch screen is set using user selected settings stored in size stability control rules 214 of the ED-NANO device 106. The processor 202 uses the information of the fixed screen size and the identified distance to determine the necessary zoom for lens of the projector 204 of the ED-NANO device 106.

In accordance with features of the invention, in the process to keep the image position substantially fixed identifies an error introduced in the distance image finder 112 when the ED-NANO device 106 of system 100 is tilted or moved. The camera 206 determines the location of the image of this infrared spectrum beam of the distance image finder 112, and the angle from the previous position. Then using basic geometry, the processor 202 determines parameters necessary for stabilization of the image including the necessary zoom for the lens of the projector 204 of the ED-NANO device 106.

Referring now FIG. 3, there are shown exemplary steps for implementing extension of keypads using a dynamic touch screen in accordance with the preferred embodiment. First a portable device 102 with a limited keypad is provided as indicated in a block 300. The portable device 102 is connected to the ED-NANO device 106 through an adapter 104 as indicated in a block 302. The ED-NANO device 106 projects one of the extended keypad images supported by the portable device 102 as indicated in a block 304. For example, the projected extended keypad includes a separately projected key for each letter of the alphabet. Then a user selection is interpreted by the ED-NANO device 106 and fed back to the portable device 102.

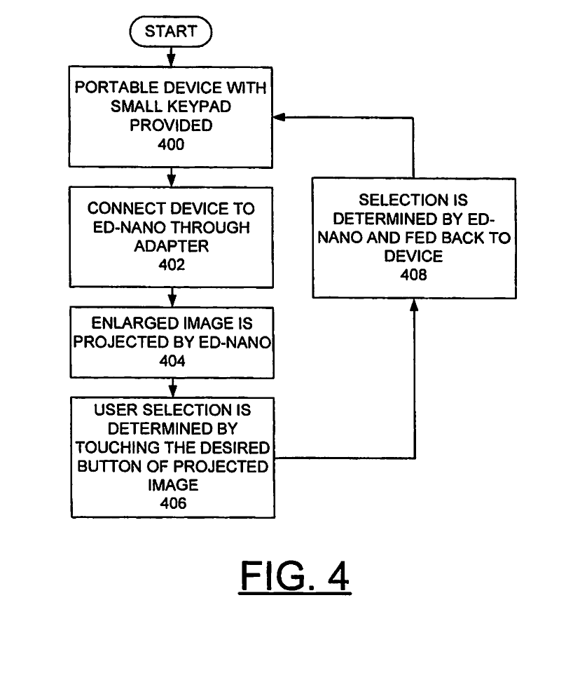

Referring now FIG. 4, there are shown exemplary steps for implementing magnification of keypads using a dynamic touch screen in accordance with the preferred embodiment. First a portable device 102 with a small keypad is provided as indicated in a block 400. The portable device 102 is connected to the ED-NANO device 106 through an adapter 104 as indicated in a block 402. The ED-NANO device 106 projects an enlarged keypad image that is supported by the portable device 102 as indicated in a block 404. For example, the projected enlarged keypad includes a separately projected enlarged key for each number and symbol for a cellular phone. A user selection is determined by touching the desired enlarged button of the projected display as indicated in a block 406. Then the user selection is determined by the ED-NANO device 106 and fed back to the portable device 102 as indicated in a block 408.

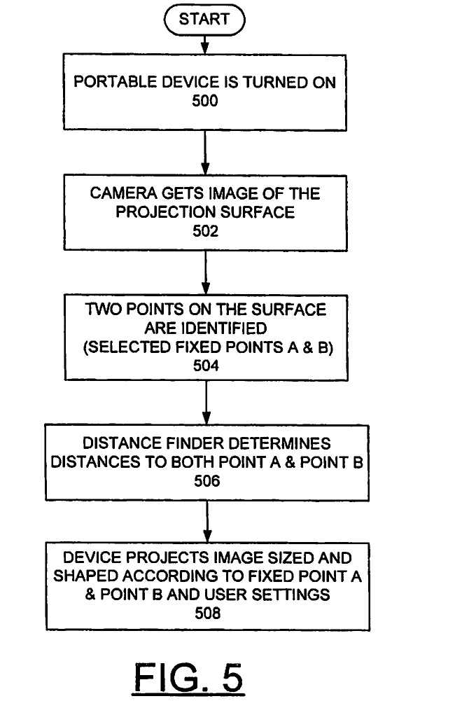

Referring now to FIG. 5, there are shown exemplary initialization processing steps in accordance with the preferred embodiment. First the portable device is turned on as indicated in a block 500. Next the camera captures an image of the projection surface as indicated in a block 502. Two points on the projection surface are identified as indicated in a block 504.

For example, a pair of selected fixed points A and B, such as illustrated in FIG. 1, are identified at block 504. Then the distance finder determines distances to both point A and point B as indicated in a block 506. Projector projects an image sized and shaped according to fixed point A and fixed point B, and user settings as indicated in a block 508.

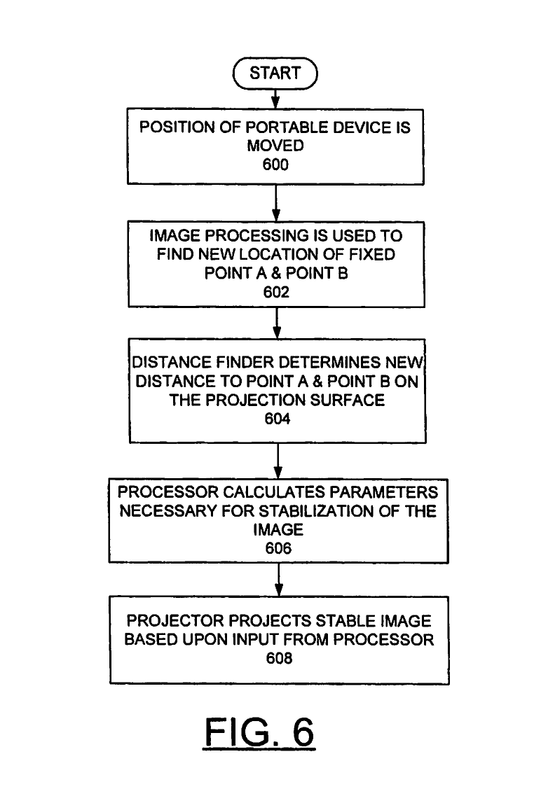

Referring now to FIG. 6, there are shown exemplary movement processing steps in accordance with the preferred embodiment. First the position of the portable device is moved as indicated in a block 600. Then image processing is used to find new location of fixed point A and fixed point B as indicated in a block 602. Then the distance finder determines distances to both point A and point B on the projection surface as indicated in a block 604. The processor calculates parameters necessary for stabilization of the image as indicated in a block 606. The projector projects stable image based upon input from the processor as indicated in a block 608.

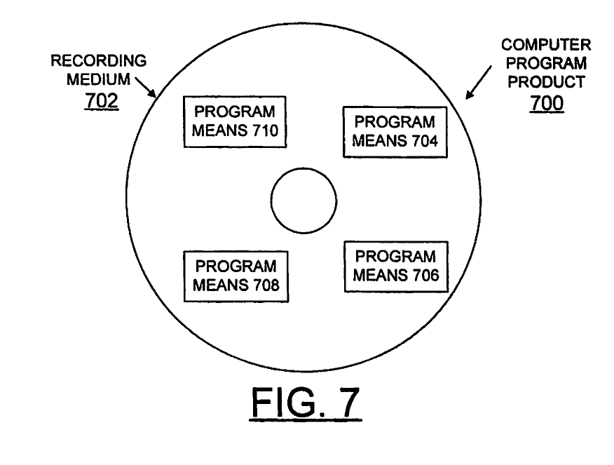

Referring now to FIG. 7, an article of manufacture or a computer program product 700 of the invention is illustrated. The computer program product 700 includes a recording medium 702, such as, a floppy disk, a high capacity read only memory in the form of an optically read compact disk or CD-ROM, a tape, or the like. Recording medium 702 stores program means 704, 706, 708, 710 on the medium 702 for carrying out the methods for implementing magnification and extension of keypads using a dynamic touch screen of the preferred embodiment in the system 100 of FIG. 1.

A sequence of program instructions or a logical assembly of one or more interrelated modules defined by the recorded program means 704, 706, 708, 710, direct the ED NANO system 100 for implementing magnification and extension of keypads using a dynamic touch screen of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. Apparatus for implementing magnification and extension of keypads using a dynamic touch screen comprising:
a portable dynamic touch-screen generating device for generating the dynamic touch screen; said dynamic touch-screen generating device including
a processor coupled to a projector for generating and projecting an image onto a surface, and a camera for detecting a user activity on the projected image; and
said dynamic touch-screen generating device identifying a user selection and applying the identified user selection to an associated functional device.

2. Apparatus for implementing magnification and extension of keypads using a dynamic touch screen as recited in claim 1 includes a memory associated with said processor, said memory storing a computer vision program.

3. Apparatus for implementing magnification and extension of keypads using a dynamic touch screen as recited in claim 2 wherein said memory stores device keyboard image magnification and extended keypad control rules, said device keyboard image magnification and extended keypad control rules used to generate magnified keypad images and extended keypad images supported by the mobile device.

4. Apparatus for implementing magnification and extension of keypads using a dynamic touch screen as recited in claim 2 wherein said memory stores size stability control rules, said size stability control rules used to calculate a size of the image projected onto the surface.

5. Apparatus for implementing magnification and extension of keypads using a dynamic touch screen as recited in claim 1 includes a distance image finder for identifying a distance from said dynamic touch-screen generating device to said surface.

6. Apparatus for implementing magnification and extension of keypads using a dynamic touch screen as recited in claim 1 wherein said dynamic touch-screen generating device is an integral unit.

7. Apparatus for implementing magnification and extension of keypads using a dynamic touch screen as recited in claim 1 wherein said dynamic touch-screen generating device is a handheld device.

8. A method for implementing magnification and extension of keypads using a dynamic touch screen comprising:
providing a portable dynamic touch-screen generating device for generating the dynamic touch screen;
said portable dynamic touch-screen generating device, generating and projecting an image onto a surface, detecting a user activity on said projected image; and
said dynamic touch-screen generating device identifying a user selection responsive to said detected user activity on said projected image.

9. A method for implementing magnification and extension of keypads using a dynamic touch screen as recited in claim 8 wherein providing said dynamic touch-screen generating device includes providing a distance image finder for identifying a distance from said dynamic touch-screen generating device to said surface.

10. A method for implementing magnification and extension of keypads using a dynamic touch screen as recited in claim 8 wherein providing said portable dynamic touch-screen generating device includes providing a compact handheld device.

11. A method for implementing magnification and extension of keypads using a dynamic touch screen as recited in claim 10 includes providing said compact handheld device including a processor coupled to a projector and a camera.

12. A method for implementing magnification and extension of keypads using a dynamic touch screen as recited in claim 11 wherein said projector projects an image onto a surface, and said camera detecting a user activity on the projected image.

13. A method for implementing magnification and extension of keypads using a dynamic touch screen as recited in claim 11 includes storing device keyboard image magnification and extended keypad control rules, said device keyboard image magnification and extended keypad control rules used by said processor to generate magnified keypad images and extended keypad images supported by the mobile device.

14. A method for implementing magnification and extension of keypads using a dynamic touch screen as recited in claim 11 includes storing size stability control rules, said size stability control rules used by said processor to calculate a size of the image projected onto the surface.

15. A method for implementing magnification and extension of keypads using a dynamic touch screen as recited in claim 11 wherein providing said dynamic touch-screen generating device includes providing a distance image finder for identifying a distance from said dynamic touch-screen generating device to said surface and includes storing size stability control rules, said size stability control rules and identified distance used by said processor to maintain a position of the image projected onto the surface.

16. A computer program product for implementing magnification and extension of keypads with a handheld dynamic touch-screen generating device; said dynamic touch-screen generating device including a processor coupled to a projector and a camera, said computer program product including instructions stored on a computer readable storage medium, said instructions when executed by a processor to cause said dynamic touch-screen generating device to perform the steps of:
generating and projecting an image onto a surface,
detecting a user activity on the projected image; and
identifying a user selection and applying the identified user selection to an associated functional device.

17. A computer program product for implementing magnification and extension of keypads as recited in claim 16 includes storing device keyboard image magnification and extended keypad control rules, said device keyboard image magnification and extended keypad control rules used by said processor to generate magnified keypad images and extended keypad images supported by an associated functional device.

18. A computer program product for implementing magnification and extension of keypads as recited in claim 16 includes storing size stability control rules, said size stability control rules used by said processor to calculate a size of the image projected onto the surface.

19. A computer program product for implementing magnification and extension of keypads as recited in claim 16 includes providing a distance image finder for identifying a distance from said dynamic touch-screen generating device to said surface and storing size stability control rules used by said processor to maintain a position of the image projected onto the surface.
